(19) United States
(12) Patent Application Publication
(10) Pub. No.: US 2005/0128504 A1
(43) Pub. Date: Jun. 16, 2005

(54) Method for printing an interrupt printing job

(76) Inventors: Patrick O. Bischel, Paris, KY (US); Robert J. Borchers, Lexington, KY (US); Cuong M. Hoang, Lexington, KY (US); Michael J. Klein, Lexington, KY (US); Francis D. Rafferty JR., Lexington, KY (US); Martin G. Rivers, Lexington, KY (US); Dave V. Snow JR., Lexington, KY (US); Aaron C. Yoder, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 10/736,970

(22) Filed: Dec. 16, 2003

(51) Int. Cl. G06F 15/00

(52) U.S. Cl. 358/1.14

(57) ABSTRACT

A method for printing an interrupt print job including the steps of receiving a primary print job and processing the primary print job with a primary processor to provide a plurality of primary pages to a print queue. The method further includes the steps receiving an interrupt print job and processing the interrupt print job with an interrupt processor to provide at least one interrupt page. The method further includes the step of printing the at least one interrupt page prior to printing at least one primary page in the page queue.

### BACKGROUND

Printers typically receive print jobs, arrange the incoming print jobs in a page queue, and print the pages in the order arranged in the page queue. However, it may be desired to print a “priority” or “interrupt” print job in an accelerated manner in advance of print jobs in the page queue. Accordingly, there is a need for a method for printing an interrupt print job, as well as a method for printing an interrupt print job which ensures easy processing of the interrupt print job.

### SUMMARY

In one embodiment, the present invention is a method for printing an interrupt print job wherein the printer includes an interrupt processor to process the interrupt print job. The dedicated interrupt processor ensures easy processing and handling of the interrupt print job.

In particular, in one embodiment the invention is a method for printing an interrupt print job including the steps of receiving a primary print job and processing the primary print job with a primary processor to provide a plurality of primary pages to a page queue. The method further includes the steps receiving an interrupt print job and processing the interrupt print job with an interrupt processor to provide at least one interrupt page. The method further includes the step of printing the at least one interrupt page prior to printing at least one primary page in the page queue.

Other objects and advantages of the present invention will be apparent from the following description and the accompanying drawings.

### BRIEF DESCRIPTION OF THE DRAWINGS

FIG. 1 is a schematic diagram illustrating a printing system which may include the system and method of the present invention;

FIG. 2 is a schematic representation of an interrupt system and method;

FIG. 3 is a schematic representation of a page queue;

FIG. 4 is a schematic representation of the page queue of FIG. 3 with interrupt pages added thereto in a first manner;

FIG. 5 is a representation of the page queue of FIG. 3 with interrupt pages added thereto in a second manner; and

FIG. 6 is a flow chart illustrating steps which may be utilized as part of the interrupt printing method and system of the present invention.

### DETAILED DESCRIPTION

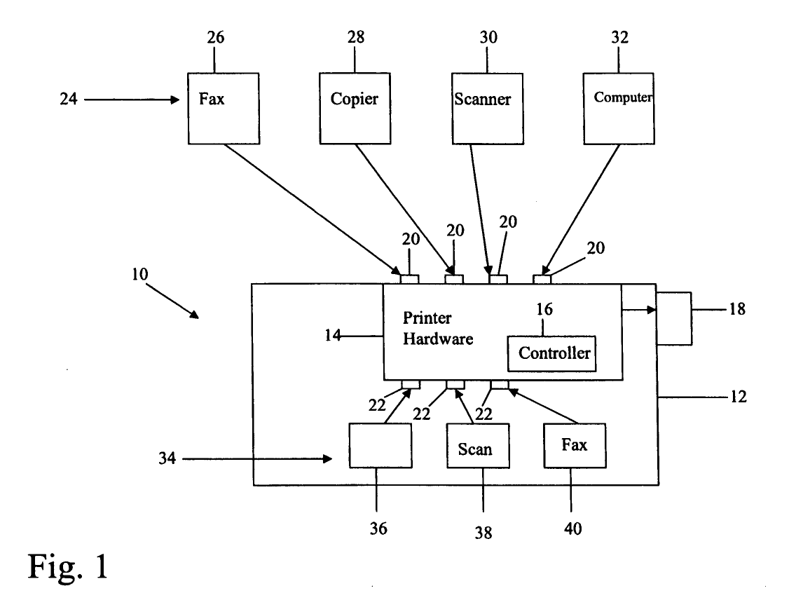

As shown in FIG. 1, the present invention may include or be implemented on a printer 10. The printer 10 may include a housing 12 and printer hardware 14 located inside the housing 12. The printer hardware 14 may include a processor, controller, chip, central processing unit, computer, circuit or various other hardware and/or software or the like (together termed a “controller”) 16 for receiving, processing, rasterizing, organizing, storing, etc. various print jobs. The printer 10 may include a print head 18 (i.e., an inkjet head, a laser-printing head, ribbon printing head or the like) or other print means coupled to the printer hardware 14 to print pages and/or other data supplied from the printer hardware 14.

The printer hardware 14 may include a plurality of external ports 20 and internal ports 22 operatively coupled to the controller 16. Each external port 20 may be coupled to an external print job source 24 that is a separate, stand alone component that is coupled to the printer 10/printer hardware 14 to transmit data streams and/or print jobs thereto (for the purposes of this application, “data stream” and “print job” are used interchangeably and have the same inclusive meaning). For example, the external print job sources 24 may include an external facsimile machine 26, external copier 28, external scanner 30 or external computer 32. The external print job resource 24 may also be a multi-function device, such as a combination printer/copier/scanner or any other device or source capable of providing a data stream. The external ports 20 may include network ports, USB ports, parallel ports, serial ports, or other type of ports as desired to receive data streams/print jobs from the various external print job sources 24.

Each internal port 22 may be coupled to an internal print job source 34 that is formed as part of, or integral with, the printer 10 such that each internal print job source 34 is located inside the housing 12. For example, the printer 10 may include an internal scanner 38, internal facsimile machine 40 or other capabilities or internal devices 36 such that the printer hardware 14 can print the data streams/print jobs provided from such internal print job sources 34. The internal ports 22 may be of the same or different configuration as the external ports 20.

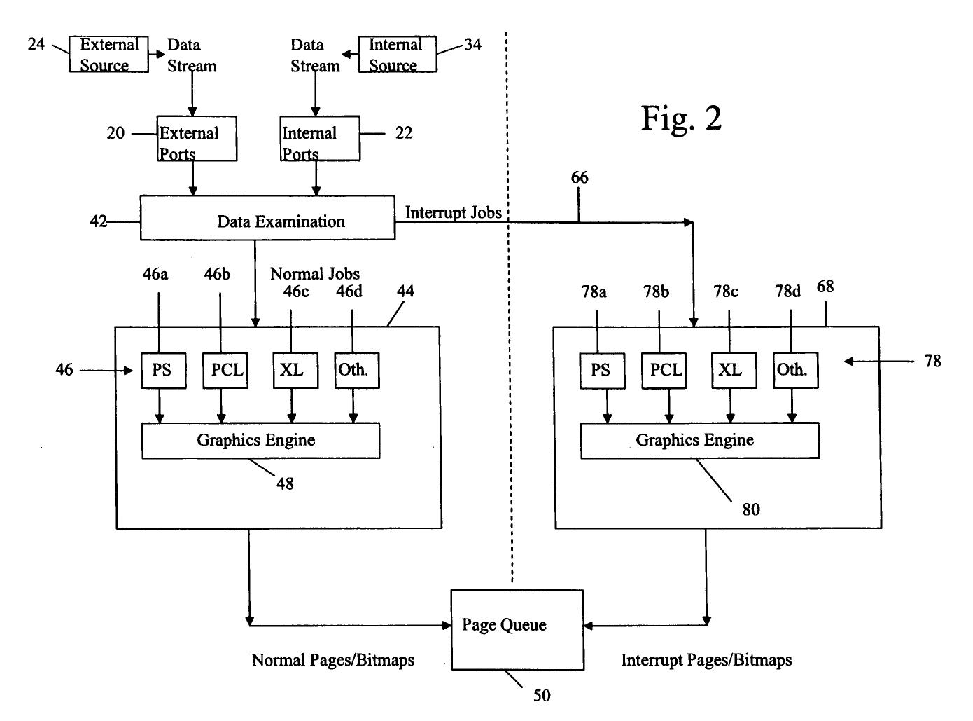

As shown in FIG. 2, data from the external 24 and internal 34 print job sources provide data streams to the external 20 and internal 22 ports, respectively. The data stream may be provided in a variety of formats, including but not limited to Postscript, PCL, XL, or other formats. Data can be received at any of the ports 20, 22 at any time, and may be received at various ports 20, 22 simultaneously. Processing of the data streams/print jobs typically occurs faster than the printing of such data streams/print jobs such that pages must be stored in a queue after they are processed while waiting for the availability of print resources (i.e., print head 18).

When the printer hardware 14 detects that a data stream/print job is being received at a port 20, 22, as shown at block 42, the controller 16 then examines or analyzes certain data of the data stream to obtain a preliminary view of the data stream (i.e., to ascertain its format, size, arrangement, organization, etc). Thus, the examination at block 42 may involve a limited review, analysis and/or processing of the data stream received through the ports 20, 22. Next, assuming that the data stream/print job received from the data port 20, 22 is determined to be a normal data stream/print job (i.e., not an interrupt data stream/print job as will be discussed in greater detail below), the data stream/print job is forwarded to a first, primary or normal processor 44.

The primary processor 44 utilizes an emulator or raster image processor 46, in conjunction with a graphics engine 48 to process the data stream. The primary processor 44 and its various components may reside in the controller 16. The primary processor 44 determines the format of the data stream (e.g., Postscript, PCL, XL, or other formats) or is provided the format of the data stream as a result of the examining step at block 42. The primary processor 44 then accesses or utilizes the appropriate emulator to match the format of the data stream. Thus the primary processor 44 may include a Postscript emulator 46a, a PCL emulator 46b, an XL emulator 46c, and/or other emulators 46d, as necessary. For example, if the received data stream is in Postscript format, the primary processor 44 invokes the Postscript emulator 46a.

The primary processor 44, by using the appropriate emulator 46, then processes or “rips” the received data streams on a page-by-page basis by converting the data streams into pages or pagemaps. The pagemaps may be in the form of uncompressed bitmaps, compressed bitmaps, display lists, or any other format which represents a page image and can be read and processed by the print head 18. The emulator 46 may refer to the graphics engine 48 during the processing of the data stream.

Upon conversion, the generated pagemaps are submitted to a page queue 50. The page queue 50 may then provide the pagemap to the print head 18 in the desired order and manner.

The data stream may include embedded flags, markers or other indicators which delineate the start of a page and the end of a page of data. Further, the data stream may include embedded flags, markers or other indicators which delineate the start and end of the data stream/print job. Alternatively, the controller 16 and/or primary processor 44 may add or embed flags, markers or other indicators which delineate the start and end of the data stream. The pages in the page queue 50 may be arranged in any desired manner, such as, for example, first-in-first-out (“FIFO”), last-in-first-out (“LIFO”) or any other desired arranging or ordering scheme.

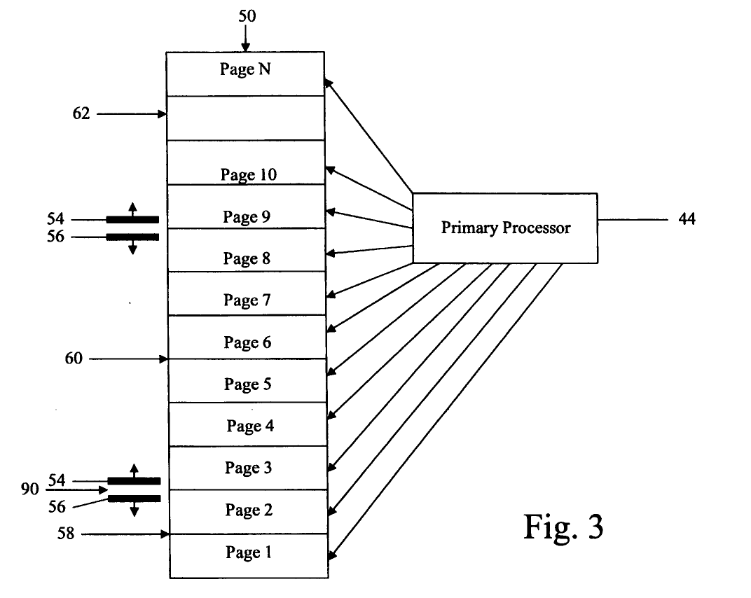

As shown in FIG. 3, the pagemaps in the page queue 50 may include a plurality of start data stream flags 54 which indicate the start of a data stream/print job. The pagemaps in the page queue 50 may also include a plurality of end data stream flags 56 which indicate the end of a data stream/print job. Thus, in the example shown in FIG. 3 the first data stream/print job 58 includes two remaining pagemaps (page 1 and page 2), the second data stream/print job 60 includes six pagemaps (pages 3-8), the third data stream/print job 62 begins with pagemap 9, etc. As shown in FIG. 3, each of the pagemaps shown therein is supplied from the primary processor 44. The pagemap (i.e., data for a printed page) at the front of the page queue 50 (i.e., pagemap 1 in FIG. 3) is then forwarded to the print head 18 and the data is converted into print commands such that the desired indicia is printed on the paper or other media by the print head 18.

A user may desire to interrupt the normal processing order of data stream. A user may also desire to interrupt the normal printing order in the page queue 50 to print an interrupt print job or pages in an accelerated manner in advance of pages pending in the page queue 50. For example, when the printer 10 includes a scanner 38, a user may desire to make immediate copies of a document by scanning the document and printing out copies in advance of the pages in the page queue 50. For many processors, once a data stream is received and begun to be processed, the processor must continue to process the data stream to its completion. In other words, it may be difficult, inefficient or time consuming for the primary processor 44 to process the interrupt job 66 in advance of the data stream currently being processed. Thus, in order to process and print an interrupt print job 66, an interrupt or secondary processor 68 may be utilized, as will be discussed in greater detail below.

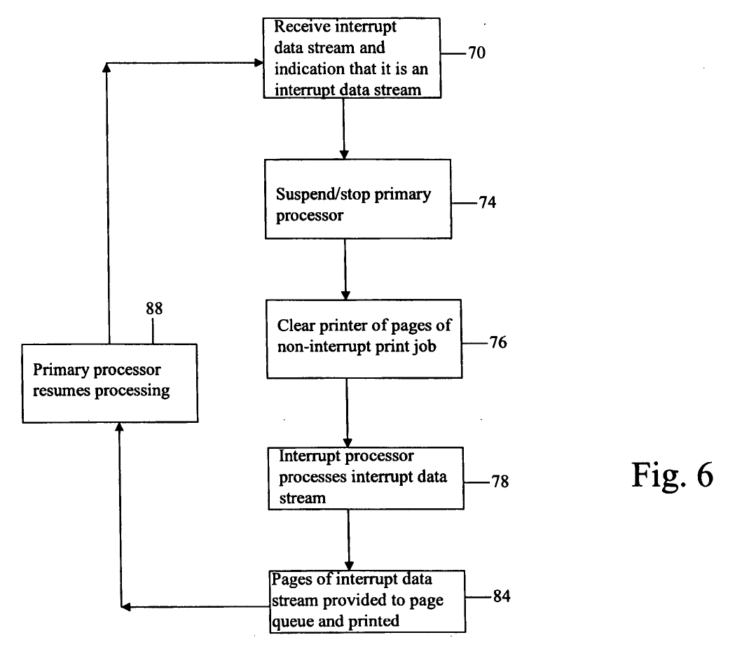

In order to process an interrupt print job, the incoming data stream must first be identified as an interrupt print job (block 42 of FIG. 2 and block 70 of FIG. 6). The data stream may include embedded flags, markers or other indicators to identify the data stream as an interrupt data stream/print job which is to be afforded higher priority or treated as an interrupt print job. The flag, marker or data may added or embedded in response to manual operation of the printer (i.e. by a user pressing a button) or by a computer 32 or other print job source 24, 34. Alternatively, the controller 16 may embed a flag, marker or other indicators to identify the data stream as an interrupt data stream/print job. Further alternatively, the controller 16/printer hardware 14 may consider every job which comes in from a particular port to be an interrupt job. For example, each data stream which is received through the internal ports 22 connected to the scanner 38 may automatically be considered to be an interrupt data stream (and the associated port may be considered to be a “dedicated” interrupt port). However the interrupt data may be provided or supplied from any of the external 24 or internal 34 job sources.

Returning to FIG. 2, when an interrupt data stream is provided to one of the ports, the controller 16 examines or analyzes the interrupt data stream at block 42. The interrupt data stream is then identified as an interrupt data stream and is forwarded to the interrupt or secondary processor 68. In order to aid in the processing of the interrupt data stream, the processing operations of the primary processor 44 are stopped or suspended such that the primary processor 44 ceases any processing (block 74 of FIG. 6). Furthermore, printing operations are stopped to enable printing of the interrupt print job 66. For example, any pages of media which are currently being printed upon, or which are picked or are moving in the printer 10, may be printed upon and moved out of the printer 10 or print path in order to make way for the interrupt print job 66 (block 76 of FIG. 6).

Once the operation of the primary processor 44 is suspended, the interrupt processor 68 processes the interrupt data stream (block 78 of FIG. 6; see also FIG. 2). As graphically represented in FIG. 2, similar to the primary processor 44, the interrupt processor 68 may reside in the controller 16 and utilizes emulators 78a, 78b, 78c, 78d and a graphics engine 80 to process the interrupt data stream. The interrupt processor 68 accesses or utilizes the appropriate emulator 78a, 78b, 78c, 78d and processes or “rips” the interrupt data stream by converting the interrupt data stream 66 into pagemaps.

It should be noted that although the primary processor 44 and interrupt processor 68 may be implemented on computer chips or central processing units known as “micro-processors” or “processors,” the primary processor 44 and interrupt processor 68 are not necessarily limited to such devices. Instead, the primary processor 44 and interrupt processor 68 should carry out the processing functions described herein, and may be implemented in or upon, or include micro-processors or processors as described above, as well as central processing units, controllers, chips, computers, circuits or various other hardware and/or software.

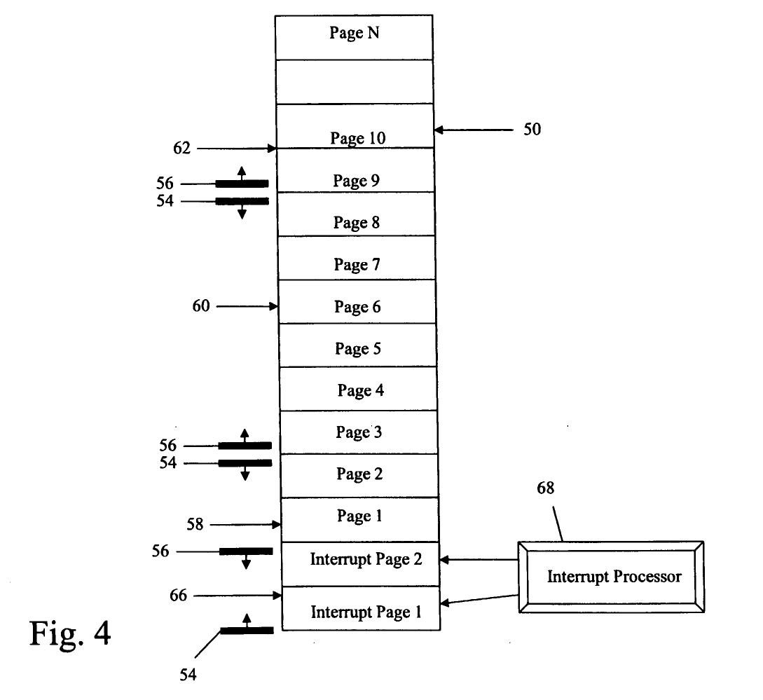

As the interrupt processor 68 processes the interrupt data stream 66, the pagemaps are submitted to the page queue 50 (see FIG. 2 and block 84 of FIG. 6). Thus, as shown in FIG. 4, the interrupt processor 68 provides interrupt pages (interrupt page 1 and interrupt page 2) to the page queue 50 for printing by the print head 18. FIG. 4 illustrates an interrupt print job 66 having two pages which is marked by a start data stream flag 54 and an end data stream flag 56, although the data stream flags 54, 56 need not necessarily be included in the page queue 50. The interrupt pages of the interrupt print job 66 are then provided to the print head 18 and printed onto the media.

Once the pagemaps of the interrupt print job 66 are generated by the interrupt processor 68 and submitted to the page queue 50, the primary processor 44 may resume its processing of any remaining data streams (i.e., print jobs 58, 60, 62) (block 88 of FIG. 6) and again supplies the pagemaps to the page queue 50 for printing. Once pagemaps of the interrupt print job 66 are printed out of the page queue 50, the printing of the remaining pages in the page queue 50 (i.e. page 1, page 2, etc. of FIGS. 3 and 4) is resumed.

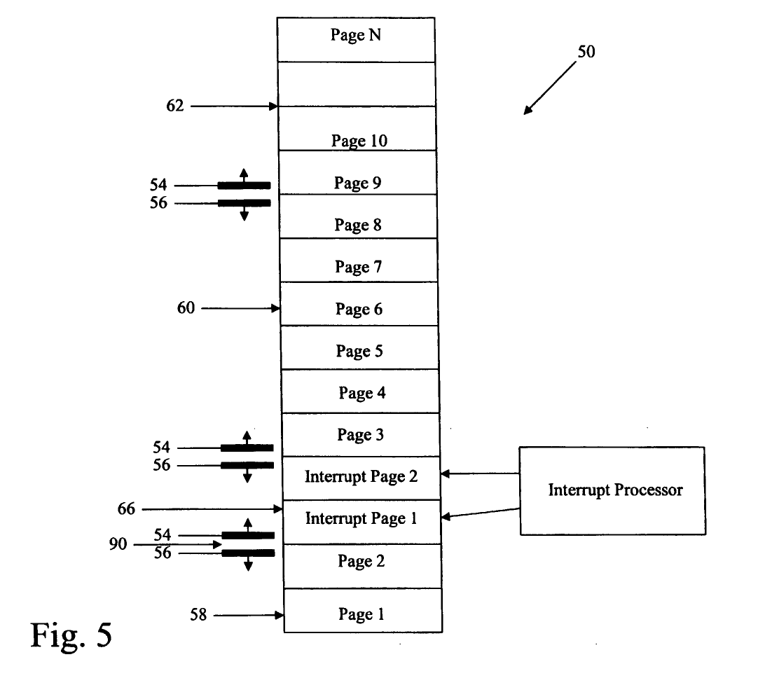

In the example outlined above, the pagemaps of the processed interrupt data stream 66 are inserted into the front of the page queue 50. However, the pagemaps of the interrupt data stream 66 may be inserted at other locations in the page queue 50. For example, in one embodiment, the pages of the interrupt data stream 66 may be printed at the first job boundary 90 in the page queue 50. For example referring to FIG. 5, it can be seen that the first primary print job 58 is in the process of being printed (i.e. only pages 1 and 2 remain to be printed) Thus, the pages of the interrupt data stream 66 may be inserted after the in-process print job 58, as shown in FIG. 5. Selection of the page boundary/job boundary option may be a default of the printer 10 or may be an option available for selection by the user.

The interrupt printing system may be configured to allow various multiple levels of interrupt printing. For example, additional interrupt print jobs may be added in the page queue 50 before or while the original interrupt data stream 66 is processed and/or printed. The newly added interrupt print job(s) may be added after the pending preexisting interrupt print job 66 such that the newly added interrupt print job(s) is printed after the original interrupt print job 66 is processed or printed. Alternatively, the newly added interrupt print job may be printed at the next page break of the original interrupt print job 66 (i.e. in an “interrupt of the interrupt” configuration) and thereby printed in advance of the original interrupt print job 66.

The interrupt processor 68 helps to ensure smooth processing of the interrupt data stream/print job 66. In particular, as outlined above, existing processors (such as the primary processor 44) may not be able to interrupt processing of a print job and/or may be not be configured to allow re-ordering or interrupting of the processing operations, or may not be able to do so in an efficient manner. Accordingly, the use of an interrupt processor 68 provides a second processor to process the interrupt print jobs and ensure smooth transition or reentry back to the primary processor 44 once the interrupt print job(s) is processed. The interrupt processor 68 also allows immediate processing and printing of the interrupt job 60.

Having described the invention in detail and by reference to the preferred nts, it will be apparent that modifications and variations thereof are possible without from the scope of the invention.

1. A method for printing an interrupt print job comprising the steps of:
receiving a primary print job;
processing the primary print job with a primary processor to provide a plurality of primary pages to a page queue;
receiving an interrupt print job;
processing the interrupt print job with an interrupt processor to provide at least one interrupt page to the page queue; and
printing said at least one interrupt page prior to printing at least one primary page in said page queue.

2. The method of claim 1, further including the step of arranging said at least one interrupt page in said page queue such that said at least one interrupt page is inserted in front of at least one primary page in said page queue.

3. The method of claim 1, wherein said at least one interrupt page is inserted into said page queue with a priority marker such that said at least one interrupt page is printed before at least one primary page in said page queue.

4. The method of claim 1, wherein said first receiving step includes receiving a plurality of primary print jobs and wherein said first processing step includes sequentially processing the plurality of primary print jobs with said primary processor to provide said plurality of primary pages.

5. The method of claim 1, wherein at least one of said primary and interrupt processors are raster image processors.

6. The method of claim 1, wherein at least one of said processing steps include rasterizing the associated print job and creating pagemaps.

7. The method of claim 6, wherein at least one of said processing steps include utilizing at least one of an emulator and a graphics engine to create said pagemaps.

8. The method of claim 1, further comprising the step of arranging the plurality of primary pages in the page queue.

9. The method of claim 8, wherein the arranging step includes arranging said primary pages said page queue in a first-in-first-out manner.

10. The method of claim 1, wherein said second processing step includes stopping said first processing step such that said first processing step is stopped during said second processing step.

11. The method of claim 10, further comprising the step of resuming said first processing step after said second processing step.

12. The method of claim 1, further comprising the step of sequentially printing the primary pages arranged in said page queue.

13. The method of claim 12, further comprising the step of stopping said sequentially printing step such that said sequentially printing step is stopped during said printing of said at least one interrupt page.

14. The method of claim 13, further comprising the step of resuming said sequentially printing step after printing the at least one interrupt page.

15. The method of claim 13, wherein said first receiving step includes receiving a plurality of primary print jobs and wherein said first processing step includes sequentially processing the plurality of primary print jobs with said primary processor to provide said plurality of primary pages, and wherein said stopping step stops said sequentially printing step at a job boundary of said primary print jobs.

16. The method of claim 13, wherein said stopping step stops said sequentially printing step at a page boundary of said primary print job.

17. The method of claim 1, wherein said receiving, processing and printing steps are all carried out by a single printing device.

18. The method of claim 17, wherein said printing device includes a plurality of ports for receiving primary print jobs or interrupt print jobs.

19. The method of claim 18, wherein at least one of said ports is a dedicated interrupt port such that each print job received by said dedicated interrupt port is designated an interrupt print job.

20. The method of claim 1, wherein said dedicated interrupt port is coupled to an internal scanner.

21. The method of claim 1, wherein said primary print job and said interrupt print job are each at least one of the output of at least one of a copier, facsimile machine, scanner, computer, and multi-function device.

22. The method of claim 1, wherein each interrupt page is printed prior to each primary page in said page queue.

23. A printer comprising:
a controller configured to receive a primary print job, process the primary print job with a primary processor to provide a plurality of primary pages to a page queue, receive an interrupt print job, and process the interrupt print job with an interrupt processor to provide at least one interrupt page; and
print means for printing said at least one interrupt page prior to printing at least one primary page in said page queue.

24. The printer of claim 23, wherein said controller is configured to arrange said at least one interrupt page in said page queue such that said at least one interrupt page is inserted in front of at least one primary page in said page queue.

25. The printer of claim 23, wherein said controller is configured such that said at least one interrupt page is inserted into said page queue with a priority marker such that said at least one interrupt page is printed before at least one primary page in said page queue.

26. The printer of claim 23, wherein said controller is configured to receive a plurality of primary print jobs and sequentially process the plurality of primary print jobs with said primary processor to provide said plurality of primary pages.

27. The printer of claim 23, wherein said primary and interrupt processors are raster image processors and are configured to rasterize the associated print job and create pagemaps.

28. The printer of claim 27, wherein said primary and interrupt processors both include an emulator and a graphics engine.

29. The printer of claim 23, wherein said controller is configured to arrange said primary pages said page queue in a first-in-first-out manner.

30. The printer of claim 23, wherein said controller is configured to stop said processing of said primary print job while said interrupt processor processes said interrupt print job.

31. The printer of claim 30, wherein said controller is configured to resume processing of said primary print job after said interrupt processor has processed said interrupt print job.

32. The printer of claim 23, wherein said controller is configured to sequentially print the primary pages in said page queue.

33. The printer of claim 32, wherein said controller is configured to stop said sequential printing during said printing of said at least one interrupt page.

34. The printer of claim 33, wherein said controller is configured to resume said sequential printing after printing the at least one interrupt page.

35. The printer of claim 33, wherein said controller is configured to receive a plurality of primary print jobs and sequentially process the plurality of primary print jobs with said primary processor to provide said plurality of primary pages, and wherein said controller is configured to stop said sequential printing at a job boundary of said primary print jobs.

36. The printer of claim 33, wherein said controller is configured to stop said sequential printing at a page boundary of said primary print job.

37. The printer of claim 23 further comprising a plurality of ports for receiving primary print jobs or interrupt print jobs.

38. The printer of claim 37, wherein one of said plurality of ports is a dedicated interrupt port such that each print job received by said dedicated interrupt port is designated an interrupt print job.

39. The printer of claim 38, wherein said dedicated interrupt port is coupled to an internal scanner.

40. The printer of claim 23, wherein said primary print job and said interrupt print job are each at least one of the output of at least one of a copier, facsimile machine, scanner, computer, and multi-function device.

41. The printer of claim 23, wherein said wherein said controller is configured such that each interrupt page is printed prior each primary page in said page queue.
